(19) United States
(12) Patent Application Publication
(10) Pub. No.: US 2007/0058898 A1
(43) Pub. Date: Mar. 15, 2007

(54) Humidity sensor and method for monitoring moisture in concrete

(75) Inventors: Jeremiah Slade, Ayer, MA (US); Jeffrey Everson, Reading, MA (US); Stephan J. Kokkins, Marion, MA (US); Susan B. Kristoff, Leominster, MA (US); Richard Lusignea, Boston, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: InfoSciTex, Waltham, MA (US)

(21) Appl. No.: 11/479,984

(22) Filed: Jun. 30, 2006

Related U.S. Application Data
(60) Provisional application No. 60/695,084, filed on Jun. 30, 2005.

(51) Int. Cl. G02B 6/00

(52) U.S. Cl. 385/12

(57) ABSTRACT

A humidity sensor and method is disclosed. The sensor is configured as an optical fiber based sensor and may be useful in obtaining moisture information, such as humidity and/or relative humidity (RH) in curing concrete. The sensor may be configured to isolate the sensor from external mechanical stresses, chemical reactions and/or temperature fluctuations that may occur in the concrete and/or at least account for such occurrences. Methods of calibrating the sensor are also disclosed. The sensor may be configured as a fiber Bragg sensor.

### CONTINUITY DATA

This application claims the benefit of U.S. Provisional Patent Application No. 60/695,084, filed on Jun. 30, 2005, which is hereby incorporated by reference in its entirety.

### FEDERALLY SPONSORED RESEARCH

The inventions herein were made with US Government support under DTRT57-05-C-10102 awarded by the US Department of Transportation. The US Government may have certain rights in these inventions.

### BACKGROUND

1. Field

Aspects of the invention relate to sensors and more particularly to sensors and methods useful for detecting humidity levels and/or temperature, for example, in curing concrete.

2. Discussion of Related Art

Sensors are employed in numerous situations to detect various environmental parameters. The information collected in turn is also used for numerous reasons. A humidity sensor is one example of such a sensor and the collected information may be used to determine the impact of moisture on various structures.

Measurement of the moisture content in concrete may be helpful for several reasons. For example, monitoring moisture ingress, which could indicate deterioration, during the service life of the concrete may be helpful to determine whether to initiate repairs before significant damage can occur.

Optical fiber based sensors have been employed as humidity sensors. However, such sensors have not proven to be robust in either longevity or data collection, such that there is a need for an improved optical fiber based sensor.

### SUMMARY

In one illustrative embodiment, a method of obtaining humidity data in curing concrete is provided. The method includes providing a fiber optic based humidity sensor; instructing placing the sensor in concrete during or after concrete is poured and prior to the concrete being fully cured; and instructing connecting the sensor to a reader that is adapted to obtain a signal from the sensor indicative of humidity in the concrete as the concrete is curing.

In another illustrative embodiment, a method of obtaining humidity data in curing concrete is provided. The method includes obtaining a fiber optic based humidity sensor; placing the sensor in concrete during or after concrete is poured and prior to the concrete being fully cured; and connecting the sensor to a reader that is adapted to obtain a signal from the sensor indicative of humidity in the concrete as the concrete is curing.

In yet another illustrative embodiment, a kit of parts is provided. The kit includes an openable, non-porous package defining a chamber. The chamber is held at a relatively high humidity. A fiber optic based humidity sensor is enclosed within the package.

In still another illustrative embodiment, a sensor assembly is provided. The sensor assembly includes a sensor having an optical fiber and a hygroscopic material covering the optical fiber. A rigid, non-brittle sleeve is disposed over the sensor. The sleeve is constructed and arranged to isolate the sensor from external stresses applied thereto when the sensor is in use.

In another illustrative embodiment, a method of calibrating a fiber optic based humidity sensor is provided. The method includes a) placing the sensor in a humidity chamber that is at a relatively high humidity, without first placing the sensor in the humidity chamber at a relatively low humidity and b) thereafter reducing the humidity within the chamber. The method also includes c) obtaining a signal from the sensor and d) correlating the obtained signal with the humidity in the chamber.

In another illustrative embodiment, a fiber Bragg sensor is provided. The sensor includes an optical fiber having a first location and a second location spaced from the first location and gratings formed on the fiber at the first and second locations. A polyimide coating is disposed on the fiber at the first location to form a humidity sensor and an acrylate coating is disposed on the fiber at the second location to form a temperature sensor. PTFE tubing is disposed over both the humidity sensor and the temperature sensor. The PTFE tubing is adapted to substantially allow water vapor to flow through the covering to the sensors and substantially prevent liquid water to flow through the covering. A porous rigid metal sleeve is disposed over both the PTFE tubing. The porous rigid metal sleeve is adapted to allow water to pass through the covering.

In yet another illustrative embodiment, a fiber Bragg sensor is provided. The sensor includes an optical fiber having a first location and a second location spaced from the first location and gratings formed on the fiber at the first and second locations. A polyimide coating is disposed on the fiber at the first location to form a humidity sensor. An acrylate coating is disposed on the fiber at the second location to form a temperature sensor. Heat shrink tubing is disposed over both the humidity sensor and the temperature sensor. The heat shrink tubing is adapted to substantially allow water vapor to flow through the covering to the sensors and substantially prevent liquid water to flow through the covering. A porous stiff metal sleeve is disposed over both the heat shrink tubing. The porous stiff metal sleeve is adapted to allow water to pass through the covering.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1A is a schematic representation of a humidity sensor at 10% RH according to one illustrative embodiment;

FIG. 1B is a schematic representation of a humidity sensor of FIG. 1A at 100% RH according to one illustrative embodiment;

FIG. 1C is a graphical representation of the output of a humidity sensor of FIGS. 1A and 1B according to one illustrative embodiment;

FIG. 2A is a schematic representation of a humidity sensor according to one illustrative embodiment;

FIGS. 2B and 2C are graphical representations of the input and output of the humidity sensor of FIG. 2A according to one illustrative embodiment;

FIGS. 3A-3C are schematic representations of a humidity sensor with a hygroscopic coating illustrating elongation according to another illustrative embodiment;

FIGS. 4A-4B are schematic representations of radial expansion of a humidity sensor according to one illustrative embodiment;

FIGS. 5 and 6 are schematic representations of fiber optic sensors including a temperature sensor and a humidity sensor according to two illustrative embodiments;

FIGS. 7 and 8 are schematic representations of systems for use with a humidity sensor;

FIG. 9 is a schematic representation of a concrete test sample according to one illustrative embodiment;

FIG. 10 is a graphical representation of Chamber RH vs. Change in CW according to one illustrative embodiment;

FIG. 11 is a graphical representation of Temperature vs. Change in CW at a constant RH of 95% according to one illustrative embodiment;

FIG. 12 is a graphical representation of CW vs. RH for a sensor with and without a protective sleeve according to another illustrative embodiment;

FIGS. 13 and 14 are graphical representations of CW vs. RH for a sensor without and with a protective sleeve when immersed in highly alkaline solution;

FIG. 15 is a graphical representation of CW vs. RH for a sensor in a concrete test sample;

FIG. 16 is a graphical representation of the measured RH vs. the calculated RH for a sensor embedded in concrete according to one illustrative embodiment;

FIG. 17 is a schematic representation of an array of fiber optic sensors within a concrete sample according to one illustrative embodiment; and

FIG. 18 is a schematic representation of a kit of parts for use with a humidity sensor according to one illustrative embodiment.

### DETAILED DESCRIPTION

Aspects of the invention are directed to a fiber optic based humidity sensor. The humidity sensor may be placed in concrete during or after the concrete is poured. The humidity sensor may be placed in the concrete prior to the concrete being fully cured to monitor the moisture in the concrete. The sensor may be permanently embedded in the concrete such that the sensor can measure the humidity from the time of its placement, through the service life of the concrete structure.

Measurement of moisture content, such as humidity/relative humidity (RH) in concrete may be desirable for several reasons. First, measuring humidity in concrete may be helpful to ensure that enough moisture is present during the curing process, that is until the hydration reaction of the cement is complete or nearly complete and the concrete has gained full or nearly full strength. Second, the measurement of humidity in concrete may be helpful to monitor moisture ingress which could indicate deterioration during the service life of the concrete, so that repairs may be made before more serious damage occurs. Other reasons may be necessitated for monitoring moisture in cured and/or uncured concrete, as the present invention is not limited in this respect.

It should be appreciated that the term “humidity” may refer generally to a measure of the moisture content in a particular environment, whereas “relative humidity” may refer to the ratio of water/fluid vapor contained in the environment compared to the maximum amount of moisture that the environment can hold at that particular temperature and pressure. Therefore, the relative humidity may be determined from the humidity based upon a particular temperature and/or pressure. However, it should also be recognized that in this application, these terms may be used interchangeably.

Aspects of the invention are also directed to a method of obtaining humidity data in curing concrete. The method may include placement of a sensor in concrete during or after the concrete is poured but prior to the concrete being fully cured. The sensor may be embedded into the freshly poured concrete, and used to validate the level of water throughout the critical cure time. In one embodiment, the critical cure time is approximately between 7-14 days. A suitable reader may be employed and may be connected to the sensor to obtain a signal from the sensor indicative of humidity in the concrete as the concrete is curing. The signal acquisition may be provided by personnel or telemetry or other suitable arrangement, as the present invention is not limited in this regard. The measurement system may be a portable interrogator or a stationary interrogator.

For applications where the moisture needs to be renewed, in one embodiment, the sensor is linked to an automated water sprinkling device, which may be triggered when the moisture level reached a minimum threshold.

In another embodiment, the sensor may be used when forming concrete flooring. Concrete flooring is often the foundation upon which additional materials, such as tile or carpet, are layered. In this particular application, it may be helpful to know when the concrete has reached a required cure and dry time before the second material may be layered over the concrete. An embedded sensor system may enable a measurement of a humidity level, and validate the decision about when to add the next layer.

In yet another embodiment, the sensor may be used to monitor the migration of chloride in concrete. This may be helpful for predicting and/or detecting corrosion near steel reinforcements in the concrete.

Yet other aspects of the invention are directed to a sensor assembly. The sensor assembly may include a sensor having an optical fiber and a hygroscopic material covering the optical fiber. In one embodiment, a rigid, non-brittle sleeve is disposed over the sensor to isolate the sensor from external stresses applied thereto when the sensor is in use. Such strain isolation may be helpful when the sensor is employed to measure moisture in certain environments, such as when used to measure moisture in concrete. In this regard, the protection sleeve may protect the sensor from impacts and other stresses when the concrete is being poured, which may result in concrete aggregate otherwise impacting the sensor.

It should be appreciated that although in some embodiments, the sensor assembly may be a humidity sensor, in other embodiments, the sensor assembly may measure other variables, such as, but not limited to, temperature, strain, pressure, etc., as the invention is not limited in this respect. Also, although some embodiments are adapted for measuring moisture in concrete, the present invention is not limited in this respect, as the sensor may be employed and/or configured to measure moisture in other environments. As discussed below, aspects of the present invention are directed to humidity sensors that may be used in other environments, such as for example, in soil, air, gas or any other suitable environment as the present invention is not so limited.

Certain aspects of the invention are directed to a fiber Bragg sensor. According to one embodiment, a fiber optic Bragg grating with a hygroscopic (water-absorbing) coating may be used to measure the humidity. In one embodiment, the sensor is accurate, durable, and cost-effective to aid in ensuring the quality of the structure in which the sensor is placed.

The optical fiber based sensor may include two sensors that measure different parameters. In one embodiment, the sensor may include an optical fiber having a first location and a second location spaced from the first location with gratings formed on the fiber at the first and second locations. A polyimide coating may be disposed on the fiber at the first location to form a humidity sensor. As discussed above, the sensor may be configured to measure other parameters either separately or in suitable combinations. In one embodiment, the sensor may also include a temperature sensor with an acrylate coating disposed on the fiber at the second location to form a temperature sensor. One or more humidity/temperature sensor combinations may be formed on a single optical fiber as the present invention is not limited in this respect. Other embodiments may include different combinations of types of sensors, as the invention is not limited in this respect.

According to certain embodiments, the sensor may be placed in a corrosive environment, such as in curing concrete. However, concrete is alkali, with a pH>10 and possibly>13, which can chemically degrade the hygroscopic coating used on the sensor. Accordingly, aspects of the invention are directed to a sensor with a protected hygroscopic polymer coating that is sufficiently sensitive and durable enough to meet the demands of a high alkaline environment, such as a concrete highway application.

A chemically resistant yet permeable outer layer may protect the hygroscopic polymer coating from the highly alkaline concrete environment, while allowing water vapor to pass through. Thus, in one embodiment, the hygroscopic coating may be protected by an outer sleeve that allows water vapor to pass through, but will prevent liquid water with dissolved ions from coming in contact with the coating. In one embodiment, the outer sleeve may include a layer of PTFE (poly tetra fluoro ethylene). Other suitable coverings may be employed, as the present invention is not limited in this respect. In one embodiment, the outer sleeve is configured as a heat shrink tube. In one embodiment, the outer layer may be approximately 2 microns thick, although other suitable thicknesses may be employed as the present invention is not limited in this respect. It should be noted that the common terminology of “micron” for “μm” is used interchangeably.

In one embodiment, a protective layer may be placed over the hygroscopic layer, prepared from a material that is permeable to water vapors but inert to chemical degradation caused by the environment within which the sensor operates. Any material that is permeable to water vapor but inert to chemical degradation may be suitable, as the present invention is not limited in this respect. Methods of preparation may also vary, and may include the use of a preformed sleeve, deposition of a coating, or other methods of application may be employed, as the present invention is not limited in this respect. Other materials permeable to water vapors that could be used for a protective coating include but are not limited to (poly)ethylene, (poly)isoprene, (poly)ethylene-co-propylene-co-diene, as the present invention is not limited to a specific protective material. Also, it should be appreciated that a protective sleeve is not required in some embodiments.

In one embodiment, PTFE tubing may be disposed over both the humidity sensor and the temperature sensor. However, in another embodiment, a protective sleeve may be disposed over the humidity sensor and not over the temperature sensor. In one embodiment, a porous rigid metal sleeve may be disposed over the PTFE tubing whereby the porosity of the sleeve allows water to pass through the sleeve, yet isolate the sensor from stresses.

In some instances, it may be desirable to provide the sensor so that it can detect a high humidity as soon as or shortly after it is placed in its working high humidity environment. This may be the case when measuring moisture content in curing concrete where the concrete starts at a relatively high humidity. Rather than wait until the sensor reaches the high humidity before data can be obtained, placing the sensor in the environment at or near the pre-existing moisture level of the environment may be helpful.

Thus, one aspect of the invention is directed to a kit of parts that includes an openable, non-porous package defining a chamber held at a relatively high humidity and a fiber optic based humidity sensor enclosed within the package. In this regard, the sensor is provided at a relatively high humidity level.

Yet another aspect of the invention is directed to a method of calibrating a fiber optic based humidity sensor. The method may include placing the sensor in a humidity chamber that is at a relatively high humidity, without first placing the sensor in the humidity chamber at a relatively low humidity. Thereafter, the humidity within the chamber may be reduced. A signal from the sensor may be obtained and the obtained signal may be correlated with the humidity in the chamber. Such a calibration methodology may speed up the calibration process because it has been found that the sensor takes longer to reach a high humidity level from a low humidity level than reaching a low humidity level from a high humidity level. Also, in embodiments where the sensor is to be employed to measure humidity in curing concrete, calibrating the sensor based on a “low-to-high” humidity scheme may not be necessary, whereas calibrating based on a “high-to-low” humidity scheme may be desirable.

As mentioned, in one embodiment, the optical humidity sensor includes a fiber Bragg grating (FBG) transducer for modulation of light propagation. As is known, the FBG transducer is based on a grating inscribed into the optical fiber, which selects a wavelength of light from incident broadband source. This wavelength is reflected back into the light source, with constructive interference producing the amplified critical wavelength (CW). Any phenomenon that shrinks or expands the distance between the grating spaces will result in a shift of the CW, which can be quantitatively related to the source of the strain on the grating. Therefore, in one embodiment, the wavelength shift may be proportional to the strain, which may be proportional to the humidity and/or relative humidity. As discussed below, the signal acquisition may be accomplished with a commercial interrogator based on a Fabry-Perot Interferrometer.

It should be appreciated that fiber Bragg grating is not required in all embodiments of a humidity sensor. It is also contemplated that other types of optical fiber sensors may also be used in certain embodiments as the invention is not so limited.

FBG sensors have been made for measurements of strain, load and temperature. In one embodiment, a FBG transducer is configured as a humidity sensor by application of a hygroscopic polymer coating to the grating region that has been inscribed into an optical fiber. The polymer coating swells with water, and induces strain on the grating, producing a shift in the critical wavelength (CW). The response is reversible and the sensor can be used to monitor fluctuating levels of moisture. As the coating absorbs and desorbs water, it expands and contracts respectively, causing strain in the FBG, which changes the Bragg spacing (the regular interval between high and low refractive index regions of the optical fiber glass). This optical fiber with the Bragg grating section may function as an interferometer when subjected to narrow-band light transmitted and detected traveling through and reflected by this grating. The change in Bragg spacing may be measured by a change in the wavelength of light with the greatest intensity reflected by the grating through the optical fiber (the critical wavelength).

The fiber Bragg grating may be inscribed at different spacings along the length of optical fiber, allowing for sensor arrays. Because of the array capability and the small dimensions of the fiber, this sensor system is suited for embedded monitoring of large structural pieces, such as highway structures or aircraft. Such sensor arrays are discussed in greater detail below.

In one embodiment, the coating may be intimately associated with the surface in the grating region. According to certain embodiments, this close association may help to enhance the humidity induced strain. Covalent attachment of the coating to the surface is one method of enhancing the coating association. Surface derivatization methods exist which create a covalent linkage between a glass surface and coating. These methods are typically based on bifunctional silanization compounds, with one ligand binding to the glass surface with silanol linkages, with the other functional group available for binding to a ligand. An example is aminopropyltriethoxysilane (APTES), which creates a reactive amine group on the glass surface. This amine may be crosslinked to a pendant group on a polymer coating, using a bifunctional crosslinker such as diisocyanato or glutaraldehyde. There are numerous strategies and compounds, using homo or heterobifunctional crosslinkers, that have been described in the literature. In one embodiment, an attachment method may covalently bond the polymer to the fiber Bragg grating, based on the pendant groups of the selected polymer. Many crosslinking reagents are listed in the catalog of Gelest Inc., and other sources. Other suitable arrangements for attaching the hygroscopic material to the fiber may be employed as the present invention is not so limited.

Fiber Bragg grating transducers may also be sensitive to temperature. As such, methods for compensating for temperature interference may be incorporated into certain embodiments of the invention. For example, in one embodiment, an algorithm may be used that computes the humidity value after the temperature effects are removed. This may require the system to separately measure temperature. Also, because the temperature may vary within the concrete, using a single ambient temperature measurement may not be adequate for requirements of accurate humidity measurement. Thus, in certain embodiments, a plurality of sensors may be employed, as the present invention is not so limited.

One approach is to make simultaneous RH and temperature measurements by inscribing spaced Bragg gratings into an optical fiber. Multiple gratings may be included on a single fiber, with signal discrimination achieved by use of different spacing periods, resulting in individual CWs for each grating. Software to use localized temperature measurement to compensate for the response from the matched sensor may also be incorporated according to certain embodiments of the present invention. However, it should be appreciated that not all embodiments of the present invention compensate for temperature variations, as the invention is not so limited.

Fiber Bragg gratings may detect an event that produces either a compression or elongation of the inscribed grating. Fiber Bragg gratings may detect changes in strain, load, temperature and humidity. This multiple sensitivity may be a source of interference or an opportunity for multi-sensitive detection schemes. If a sensor was employed for detection of humidity and strain, then the grating may need protection from local strain, such as with a mechanical housing. The housing may have high permeability to water vapor, by use of holes or slots in the material, or by construction with an open mesh tubing to allow water vapor to act on the hygroscopic material. A sensor housing may be provided to de-couple strain influence by enclosure of optical fiber into a protective tubing, which has flexibility to allow the ends of the tubing to move without straining the optical fiber.

The sensor may function as an humidity sensor for a variety of embedded and non-embedded applications. One application may be monitoring water ingress into composite components, such as on aircraft. Another application may be monitoring water contamination in fuel tanks. Yet another application of a humidity sensor includes highway and/or building applications such as bridge decks, columns, piers, foundations, pavement slabs, and other highway structures. Commercial applications are also contemplated by the present invention, including building floors, architectural structures, airport runways, dams and general civil engineering structures. It should be appreciated that the humidity sensor of the present invention may be used in a variety of different applications, as the invention is not so limited.

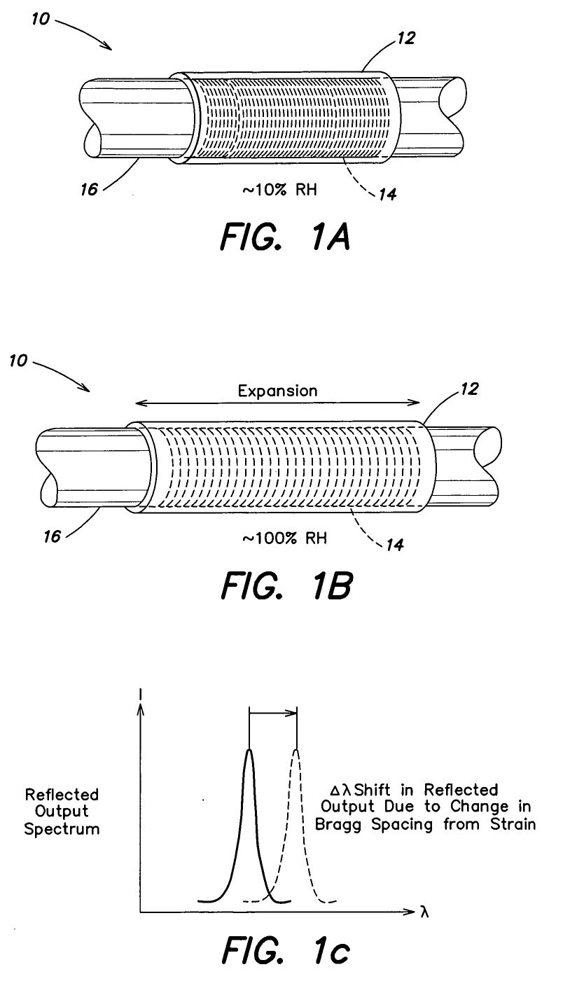

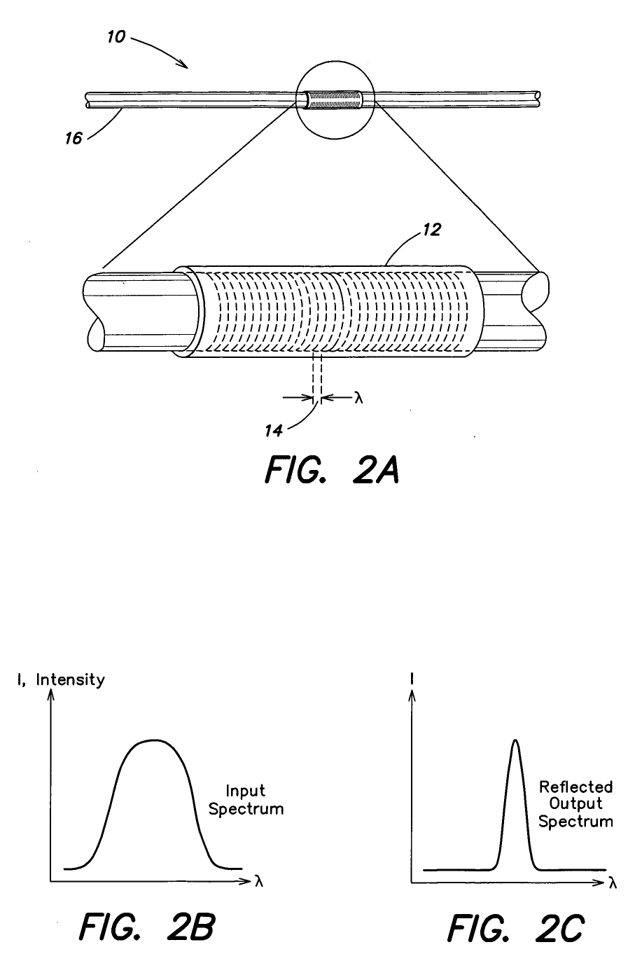

Turning to the figures, and in particular to FIGS. 1A-1C and 2A-2C, a fiber Bragg grating humidity sensor 10 is illustrated. The sensor 10 includes an optical fiber 16 with at least one region of Bragg grating. A hygroscopic coating 12 extends around the grating. The hygroscopic polymer coating 12 reversibly expands and contracts with absorption and desorption of water vapor, causing the FBG spacing 14 to change. The Bragg spacing 14 is shown in more detail in FIG. 2A. As illustrated through a comparison of FIGS. 1A and 1B, as the humidity in the environment increases, the coating expands. FIG. 2A illustrates an exemplary input signal, and FIGS. 1C and 2C illustrate an exemplary output signal. As shown in FIGS. 1C and 2C, the output signal may include a peak wavelength. As shown in FIG. 1C, the resulting output shifts due to the change in the Bragg spacing. This shift can be used to determine a change in a measured parameter in the working environment.

The Bragg grating spacing has a particular critical wavelength that may be measured by an instrument, and in one embodiment, may also be stored on a computerized data acquisition system. In one embodiment, low power laser light at, for example, 1550 nm in the near-IR range, travels down and back in the fiber to produce the interference peak sensed by the monitoring unit. Additional details regarding light transmission through the sensor is described in greater detail below.

The fiber Bragg grating (FBG) sensor may employ a commercial optical fiber used in the telecommunication industry. This type of optical fiber may normally be coated with a standard acrylic polymer that provides resistance to mechanical abrasion and chemicals, including water vapor. However, acrylics may not absorb much moisture, and thus may not suitable to cause expansion and contraction as the humidity increases and decreases. Therefore, over the region of the FBG, the acrylic coating is stripped away using standard procedures, and replaced by a hygroscopic coating that absorbs and desorbs moisture, and thereby produces strain in the FBG.

In one embodiment, a known hygroscopic polymer, such as a polyimide coating formulation commercially available as Pyralin 2525 from HD Microsystems is used with a commercially available FBG and readout system. In this embodiment, a protective coating may be used to prevent degradation of performance by the alkaline environment without significantly degrading sensitivity.

Although in one embodiment, the hygroscopic coating is polyimide, it should be appreciated that other hygroscopic coatings are also contemplated as the present invention is not limited in this respect. For example, in one embodiment, the hygroscopic polymer may be prepared from polymers such as cellulose acetate, butyrate, cellulose acetate propionate, carboxymethyl cellulose, acrylic, diethylene glycol, dextrins, gelatin, polyvinyl alcohol and aryl(meth)acrylates.

In one embodiment, three hygroscopic polymer coatings were identified based on high coefficient of humidity expansion, high modulus, good adhesion to glass, and potentially acceptable resistance to the alkaline environment in concrete. These are polyimide, nylon, and a mixture of acrylic polymer and a desiccant powder. However, in other embodiments, it should be appreciated that other hygroscopic coatings may be used as the invention is not so limited.

In one embodiment, a hygroscopic polymer coating made from polyimide approximately 50 microns thick over an optical fiber approximately 125-micron diameter may produce a strain of greater than 7 mm/mm per % RH. The strain may be reversible as the coating absorbs, desorbs and re-absorbs moisture. In one embodiment, the hygroscopic strain may produce a change in length of greater than 3.5 μm per % RH, which can be measured to an accuracy of 1 μm or less.

In one embodiment, the diameter of the optical fiber is 0.225 mm, and the thickness of the hygroscopic coating is 10 μm. In another embodiment, the thickness of the coating is 25 μm, and in another embodiment is 50 μm. However, it should be appreciated that in other embodiments, the diameter of the optical fiber and the thickness of the hygroscopic coating may be reduced or increased depending upon the particular application. It should be appreciated that the size of the optical fiber and the thickness of the coating may vary according to the particular application, as the invention is not so limited.

The fiber Bragg grating is an alternating series of two layers with slightly different indices of refraction spaced at regular intervals. Narrow-band light may be injected into the fiber by the commercial detection equipment. For example, in one embodiment, the band of light may be within a near-IR band within a range of approximately 1500 nm to approximately 1600 nm. Some of the incident light may be reflected at each interface. If only one high/low interface existed, a very small amount of light (<1%) may be reflected. However, over thousands of interfaces, the reflections add up, and constructively interfere with one another at a particular wavelength, called the Bragg wavelength, equal to 2nP, where n is the average refractive index and P is the period of the grating. In one embodiment, a grating is used with a period of 535 nm to reflect light at a Bragg wavelength of approximately 1550 nm.

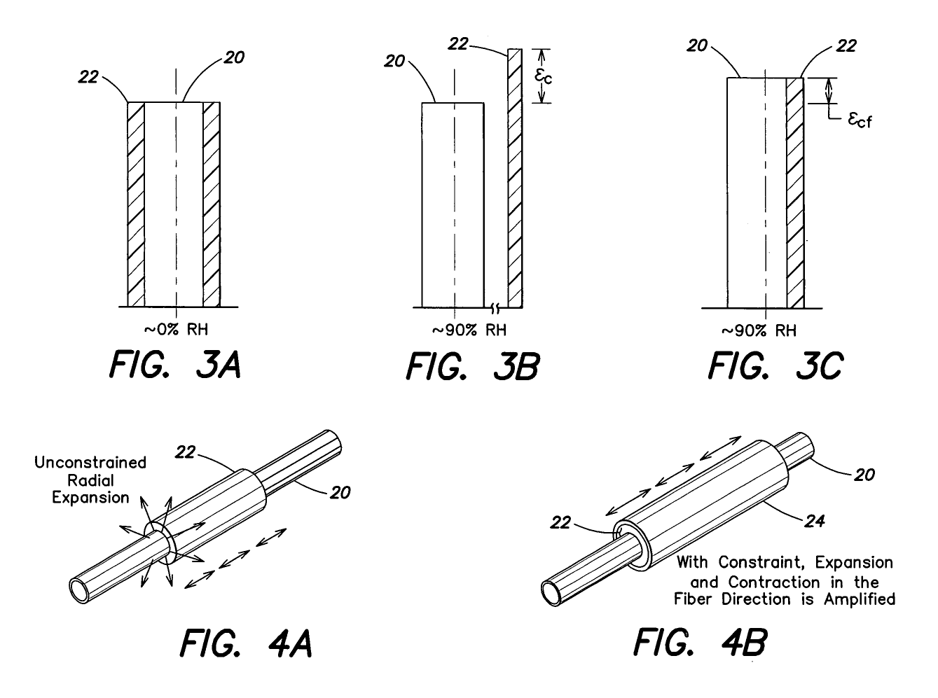

FIGS. 3A-3C illustrate a schematic representation of the effect of humidity on the coated optical fiber. In FIG. 3A, the coated fiber 20 is at approximately 0% RH, and in FIGS. 3B and 3C, the humidity is high, at 90% RH, such that the coating 22 has absorbed moisture and has expanded, while the optical fiber 20 absorbed almost no moisture and does not expand. As shown in FIG. 3B, if the coating 22 were free to expand independently of the fiber 20, it would expand by the strain shown, ε_{c}, which is equal to β_{c}(RH %), where β_{c} is the coefficient of humidity expansion (CHE), of the coating 22. However, the coating 22 is bonded to the fiber 20 over the length of the fiber. Therefore, as shown in FIG. 3C, the expansion of the coating 22 lengthens the fiber 20 core, and the fiber core restrains the coating from expanding as much as it would freely. Based on a simple one-dimensional model, without Poisson strain effects, the combined coating-fiber CHE, Pcf, is given by:
β_{cf}=(β_{c}A_{c}E_{c}+β_{f}A_{f}E_{f})/(A_{c}E_{c}+A_{f}E_{f})

In the above equation, A is the cross sectional area, E is the modulus of elasticity, and subscripts c and f refer to the coating and fiber, respectively. This calculation may also be similar for determining the coefficient of thermal expansion, or α.

In the case of β, that of the optical fiber is effectively zero, so the relation reduces to:
β_{cf}=(β_{c}A_{c}E_{c})/(A_{c}E_{c}+A_{f}E_{f})

The sensitivity of the humidity sensor made from coating a FBG may be improved by increasing the β_{c}, the coating thickness (represented by A_{c}), and the E_{c}. Thus, in one embodiment, a coating may be selected to maximize those factors.

Table 1 shows the properties of optical glass fiber and polyimide. Optical glass fiber has a modulus of approximately 69 GPa and diameter of 127 μm, and polyimide has a modulus of approximately 3.5 GPa and CHE of 22 (10⁻⁶) % RH⁻¹. At a coating thickness of 50 μm, the cross-sectional area of the polyimide is 0.0148 mm² and the area of the glass fiber is 0.0127 mm². β_{cf} of the coated glass fiber is calculated using the above equation at 2.0 (10⁻⁶) % RH⁻¹.

TABLE 1
Coefficient of Humidity Expansion, β, and Modulus

| | | Modulus of | |
|---|---|---|---|
| | | Elasticity, | |
| Material | β, 10⁻⁶ % RH⁻¹ | GPa | Dimension |
| Optical glass | ˜0 | 69 | 127 μm diameter |
| fiber | | | |
| Polyimide | 22 | 3.5 | 30 μm coating thickness |

The sensitivity to change in RH, may be determined by:
Sensitivity=β_{cf}(P)

In the above equation, P is the period of the Bragg grating, and as discussed above, β_{cf} is the coefficient of humidity expansion (CHE). In one embodiment, the period of the Bragg grating, P, is approximately 535 nm. Using the values above, the sensitivity is approximately 1.1 pm-% RH⁻¹. As discussed in greater detail below, the sensitivity of 50-micron thick coated FBG sensors in the range of 2.1 to 3.9 pm-% R⁻¹. The difference may be due to actual values of CHE and modulus vs. those from Table 1.

In one embodiment, a sensitivity of 3.9 pico meter (pm) per % RH may be achieved for a 50-micron thick polyimide hygroscopic coating, based on the change in critical wavelength (CW) of the FBG. This corresponds to 7.3 (10⁻⁶) strain per % RH, and is within the operational range of the FBG signal conditioning and readout (±1 pm change in wavelength).

As illustrated in FIGS. 4A-4B, to increase the sensitivity of the coated FBG humidity sensor, an outer constraining layer may be incorporated into the sensor to limit radial expansion, and thereby amplify the expansion in the longitudinal fiber direction through the Poisson effect. For example, in one embodiment the FBG region of the optical fiber 20 is wrapped with a very small diameter Kevlar® filament around the circumference of the coated FBG. The filaments may be obtained from fabric samples by separating yarn from the fabric, and then separating a small bundle of filaments from the yarn. The filaments may be wrapped around the FBG by hand and a heat lamp may be used to raise the temperature of the filament wrap to approximately 90° C., to start a cure reaction. In another embodiment, filaments may be embedded in the hygroscopic coating, and oriented in the hoop direction produce strain amplification of a factor of 3 times.

In one embodiment, a wrapped sensor may include approximately 10 wraps of Kevlar filaments over the FBG region. In another embodiment, approximately 20 wraps are used over the FBG region. In certain embodiments, there may be an increased change in CW for the wrapped sensor vs. the same change in humidity for the same sensor when it was unwrapped. It should be appreciated that in some embodiments, the CW may increase when the filaments are aligned in a circumferential direction.

In another embodiment, a sleeve 24 may be heat shrunk around the sensor. For example, in one embodiment, a Teflon® sleeve may be placed over the FBG, then shrunk against the FBG to increase the longitudinal sensitivity. In one embodiment, the radial expansion limiting expansion sleeve may also include properties to protect the hygroscopic material from the effects of high pH environments. In one embodiment, an approximately 2-micron diameter fiber is wrapped around the optical fiber.

The hygroscopic polyimide may be isotropic and thus it expands equally in all directions when it absorbs moisture. As illustrated in FIGS. 4A-4B, radial expansion of the hygroscopic coating 22 may place no to little strain on the optical fiber 20. However, by placing a sleeve 24 around the coating 22 expansion and contraction of the coating in the direction of the optical fiber 20 may be amplified. In some embodiments, only expansion in the direction of the fiber exerts strain. As a first approximation, the three linear orthogonal properties (x, y and z directions) should add to give the volumetric property. Therefore, in one embodiment, by constraining expansion in two directions, the expansion in the third may increase by a factor of 3.

Table 2 summarizes several possible polymer coating materials and the qualitative properties for those materials. Although in one embodiment, a polyimide coating is used, the present invention is not limited in this regard, and other suitable coatings, such as those listed in Table 2 and others, may be employed.

TABLE 2
Polymer Coatings for FBG Humidity Sensor

| | Coefficient | Alkaline | | |
|---|---|---|---|---|
| Polymer | of Humidity | Chemical | Modulus of | |
| Coating | Expansion | Resistance | Elasticity | Processability |
| Polyimide | High | Moderate | High | UV curable |
| | | | | liquid |
| Polyamide | Very high | Good | Moderate | Soluble |
| (nylon) | | | | coating |
| UV curable | High, actual | Very | Moderate | UV curable |
| epoxy with | value | good | | liquid |
| hygroscopic | dependant | | | |
| filler | on blend | | | |
| Anisotropic | 2 to 3 times | As good | As good | Dependent on |
| reinforced | higher than | as basic | as basic | basic polymer |
| hygroscopic | isotropic | polymer | polymer | |
| polymer | value | | | |

In one embodiment, as mentioned, a protective sleeve is placed over the FBG sensor to enable the sensor to be used in the presence of highly alkaline concrete pore water (for example, where the pH is greater than 13). In contrast, prior sensors placed in concrete failed within 48 hours due to the high pH level. This sleeve material may allow only water vapor to permeate through the sleeve. This protective sleeve may slow the response time but may not alter the magnitude of the CW shift.

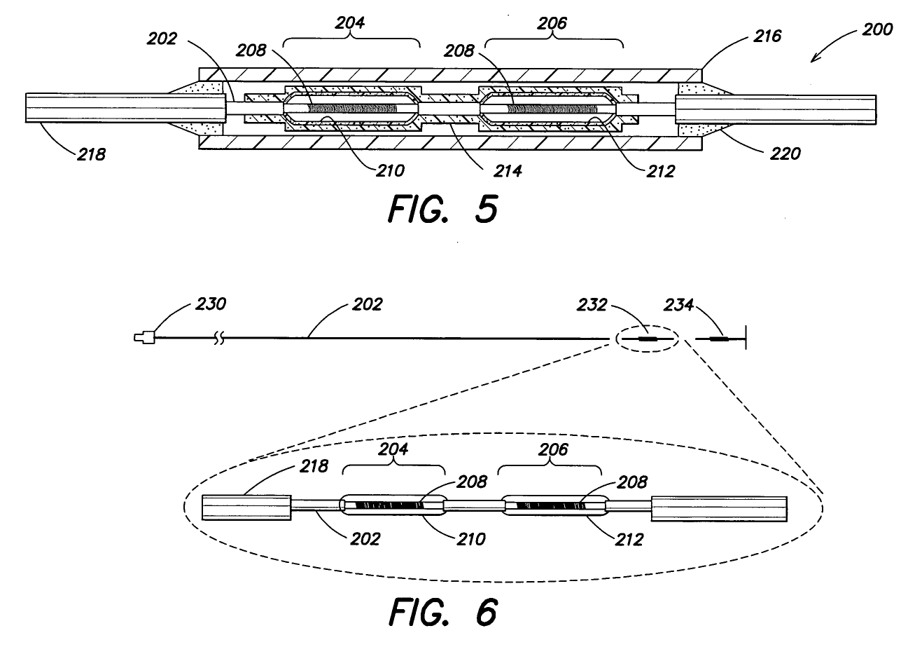

Turning now to FIG. 5, one illustrative embodiment of a fiber optic sensor with a protective container or sleeve will be more fully described. This particular fiber Bragg sensor 200 includes an optical fiber 202 having a first location 204 and a second location 206 spaced from the first location 204. Gratings 208 are formed on the fiber at the first and second locations 204, 206. A polyimide coating 210 is disposed on the fiber at the first location 204 to form a humidity sensor and an acrylate coating 212 is disposed on the fiber 202 at the second location 206 to form a temperature sensor. A protective sleeve 214 is disposed over both the humidity sensor and the temperature sensor. The protective sleeve 214 may be selectively permeable such that it is adapted to substantially allow water vapor to flow through the covering to the sensors and substantially prevent liquid water to flow through the sleeve. A porous rigid sleeve 216 is disposed over the protective sleeve 214. The porous rigid sleeve 216 may be provided to isolate the sensor from mechanical strain and may be adapted to allow water to pass through. In one embodiment, the rigid sleeve 216 may also protect the sensor from being damaged during installation. As illustrated in the embodiment of FIG. 5, a protective tube 218 may be provided on each side of the sensor 200, and may for example include a PTFE tube. An adhesive 220 may couple the protective tube 218 to the porous rigid sleeve 216.

In one embodiment, the optical fiber 202 is a standard SMF-128 acrylate coated fiber having an outer diameter of approximately 250 μm, and the selectively permeable protective sleeve 214 has a thickness of approximately 50 μm (0.002 inches). The porous rigid sleeve 216 may have an outer diameter of approximately 0.083 inches and an inner diameter of approximately 0.039 inches. Furthermore, the protective tube 218 may have an outer diameter of approximately 762 μm (0.030 inches) and an inner diameter of approximately 305 μm (0.012 inches). However, it should be appreciated that the present invention is not limited to any particular size, as the invention is not so limited. Also, it should be recognized that certain embodiments of the present invention do not include all of the components featured in FIG. 5.

The sensor may be isolated from mechanical strain in the concrete. In one embodiment, a sensor includes a stiff non-brittle sleeve or container disposed over the sensor, to isolate the sensor from external applied stresses when the sensor is in use. In one embodiment, the sleeve is a metal sleeve, such as stainless steel. Other suitable metals may be used, as the invention is not so limited. The container may be rugged, which, as used herein is one that is adapted to withstand tensile forces, shear forces, impact forces and/or buckling. In one embodiment, the container may be porous to allow water and/or vapor to pass through. However, it should be appreciated that the rugged container may be configured from a variety of materials, as the present invention is not so limited.

In one embodiment, the porous metal sleeve has a length of approximately 3.25 inches, has an inside diameter of approximately 0.039 inches and an outside diameter of approximately 0.083 inches. The pore diameter may be approximately 0.012 inches, the spacing between pores may be approximately 0.039 inches, and there may be at least 4 rows of pores along the sleeve. It should be appreciated that in other embodiments, the material, size and configuration of the sleeve may vary as the present invention is not limited in this regard.

Turning to FIG. 6, another illustrative embodiment of a fiber optic sensor including both a temperature sensor and a humidity sensor will be more fully described. As shown, the optical fiber 202 may be coupled to a reader 230 that is adapted to obtain a signal from the optical fiber. It should be appreciated that the reader 230 may be positioned remote from one or more sensors along the optical fiber 202. For example, in one embodiment, the reader 230 may be at least approximately 150 feet away from a sensor.

The optical fiber 202 may include a plurality of sensors along its length. The embodiment in FIG. 6 illustrates a first pair 232 of sensors, which may be spaced apart from a second pair 234 of sensors. In one embodiment, the first pair 232 is approximately 5 feet away from the second pair 234 of sensors. It should be appreciated that the number of sensors and pairs of sensors may vary according to the particular application, as the invention is not limited in this respect. Furthermore, as discussed in greater detail below, a plurality of sensors may be configured in an array along a single optical fiber as well.

The particular pair 232 of sensors illustrated in FIG. 6 include two fiber Bragg sensors on an optical fiber 202 having a first location 204 and a second location 206 spaced from the first location 204. Gratings 208 are formed on the fiber at the first and second locations 204, 206. A polyimide coating 210 is disposed on the fiber at the first location 204 to form a humidity sensor and an acrylate coating 212 is disposed on the fiber 202 at the second location 206 to form a temperature sensor. As illustrated in the embodiment of FIG. 6, a protective tube 218 may be provided on each side of the sensor 200. The protective tube may be placed only over a portion of the sensor that may be susceptible to the corrosive effects of the working environment.

The fiber 202 may include a standard acrylate coating with 15 mm length portions of the coating stripped away at both the first location 204 and the second location 206 for the polyimide coating 210 and the acrylate coating 212. Each grating 208 may extend approximately 10 mm in length. In one embodiment, the outer diameter of the humidity sensor is approximately 225 μm, and in one embodiment, the outer diameter of the temperature sensor is approximately 300 μm. Furthermore, in one embodiment, the polyimide coating is approximately 50 μm thick. However, it should be appreciated that in other embodiments, the dimensions and sizes may differ, as the invention is not so limited.

According to one embodiment, the humidity sensor may be prepared with FBG sensors from Avensys/Bragg Photonics, coated with a brand of polyimide called Pyralin 2525. Avensys may use a Vytran optical fiber re-coater to apply the Pyralin in a multi-step process to build up the thickness. In some applications, the Vytran re-coater is used to apply an acrylic polymer coating over splices in optical fiber, where the original acrylic coating is removed to make the splice. The acrylic coating resins may initially be in a liquid state so that they can be pumped in the Vytran re-coater for a bottle to a small cylindrical mold around the section of the fiber to be coated. The liquid acrylic resin may then be “cured,” which is a chemical reaction that causes the molecules to increase in molecular weight and cross-link, forming a solid stable chemically resistant coating.

In one embodiment, the coating may be made using polyimide instead of acrylic resin, and a modified procedure for applying and curing the polyimide may be required. Acrylic resins used in the telecommunication industry may be designed to fill the mold in the liquid state, and then cure with a small amount of shrinkage. Polyimide resins were not designed for coating optical fibers; rather they were designed for coating flat substrates used in electronic circuits, where higher amounts of shrinkage are acceptable. The solids content of Pyralin is about 15 to 30% by volume, so shrinkage will cause on the order of 3 to 7 times reduction in diameter from the filled mold to the final coated fiber. This means that in one embodiment, the maximum thickness of polyimide that can be applied in one step may only be about 5 to 10 microns. In one embodiment, thicker coatings require three to ten multiple steps to build up to 25 to 50 microns or more. However, it is also contemplated that using a higher solids content polyimide, and/or replacing the polyimide with a hygroscopic resin with much less shrinkage may allow thicker coatings.

To complete the chemical reaction from liquid precursor to solid polyimide temperatures of approximately 280 to 300° C. may be required for about 1 hour. However, this may degrade the acrylic coating. Therefore, in one embodiment, a much lower temperature, such as approximately 180 to 200° C. is used for approximately 1 hour to achieve a partial reaction of the polyimide. Although the coatings may not be fully “imidized,” the coatings may exhibited repeatable humidity absorption and desorption. It is contemplated that in other embodiments, higher temperature fiber coatings may be implemented that would allow higher treatment temperatures on the polyimide coating. However, in some embodiments, the partially imidized coating may provide enough thermal capability for concrete humidity and/or relative humidity applications. Other suitable processing techniques may be employed, as the present invention is not limited in this regard.

Light at the FBG center wavelength may be reflected because of constructive interference at many high/low index interfaces at regular spacing in the Bragg grating. Incident light in the optical fiber may be reflected at each high/low interface. Although the change of index of refraction may be very small, based on the irreversible increase caused by the high intensity light, there are many reflections over the length of the grating. At a particular wavelength, the reflected light from adjacent interfaces will be in phase producing constructive interference. With over hundreds or thousands of interfaces in the grating, almost all the incident light at that frequency will be reflected, and will not be transmitted. Thus, the Bragg grating may act as a good mirror for a specific wavelength, or a very good band-reject filter at that wavelength.

As noted earlier, the coating on the FBG sensor is hygroscopic, exhibiting reversible expansion and contraction based on absorption and desorption of moisture. The coating may also expand and contract reversibly with changes in temperature. This thermal expansion may be reversible and repeatable. In one embodiment, thermal expansion results in a strain of approximately 10.1 (10⁻⁶) mm/mm per ° F.

Because the coated FBG may respond to both humidity and temperature, the effect due to the temperature change may be calculated to determine the humidity. For example, in one embodiment, the temperature is known and is used to compensate for its effect to calculate the value of the humidity. Therefore, by measuring both the temperature and the FBG output, the change due to temperature alone may be calculated and subtracted from the FBG output to obtain the value of humidity. In one embodiment, the thermally-induced strain in the FBG sensor may be approximately 5.4 pm per ° F. (9.7 pm per ° C.), corresponding to a strain of 10.1 (10⁻⁶) strain per ° F. Thermal strain may be calculated and subtracted, for example with software, to provide a temperature compensated humidity measurement.

Any suitable temperature sensor may be used, as the present invention is not so limited. However, in one embodiment, another optical fiber based sensor, such as a FBG sensor is used to measure temperature.

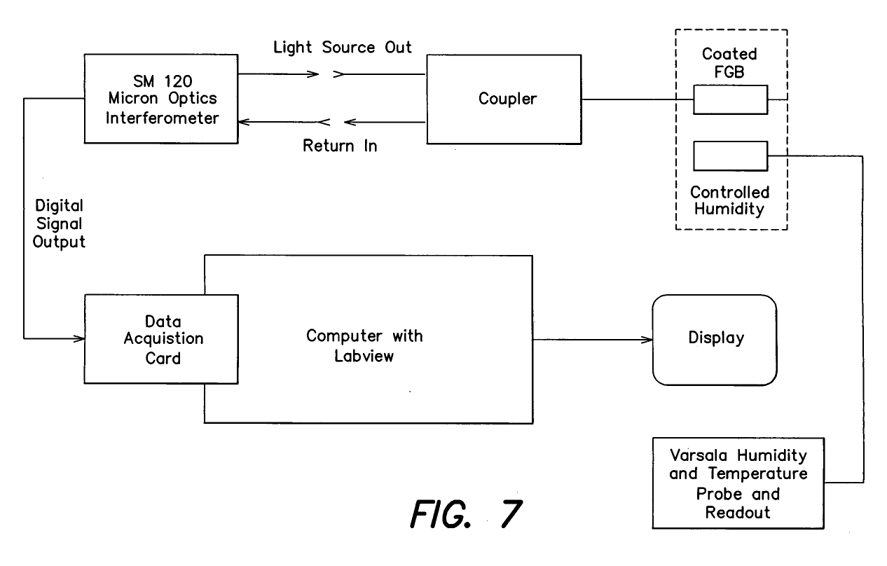

As illustrated in the schematic of FIG. 7, in one embodiment, a system may be provided for use with a sensor. The data obtained from the sensor may be stored, retrieved, and/or analyzed with the system. For example, signal conditioning and readout devices may be provided for converting strain in the FBG sensor to digital data that can be stored, retrieved and analyzed. In one embodiment, a device such as the SM120, made by Micron Optics, is used which provides a broadband source of light from approximately 1500 to 1600 nm. This type of device may be attached to the optical fiber by a standard coupling (also called a “circulator”) which may direct light to illuminate the FBG and receive reflected light from the FBG. The coupler may be similar to a half-silvered mirror in an optical bench setup, placed at an angle to the illuminating beam so that reflected light from the device is not over-ridden by the illumination.

The reflected light from the FBG may be “interrogated” by a Fabry-Perot interferometer in the SM120. This is a narrow band-pass filter that sweeps over the range of wavelengths, and a photo detector measures the intensity of the filtered light, such that the intensity can be displayed as a function of wavelength. A program in the SM120 may calculate the wavelength where the peak intensity occurs, so that the accuracy of this peak is ±1 pm, even though the spacing of data points may be greater than 1 pm, and the peak may fall in between two data points. In one embodiment, the value of the wavelength may be recorded digitally by software, such as Lab View® software, available from National Instruments, of Austin, Tex. and collected data is analyzed by software, such as Matlab® software, available from MathWorks, Inc of Natick, Mass. Other data including humidity measured by a calibrated probe, temperature, and time may also be recorded in the Lab View® program.

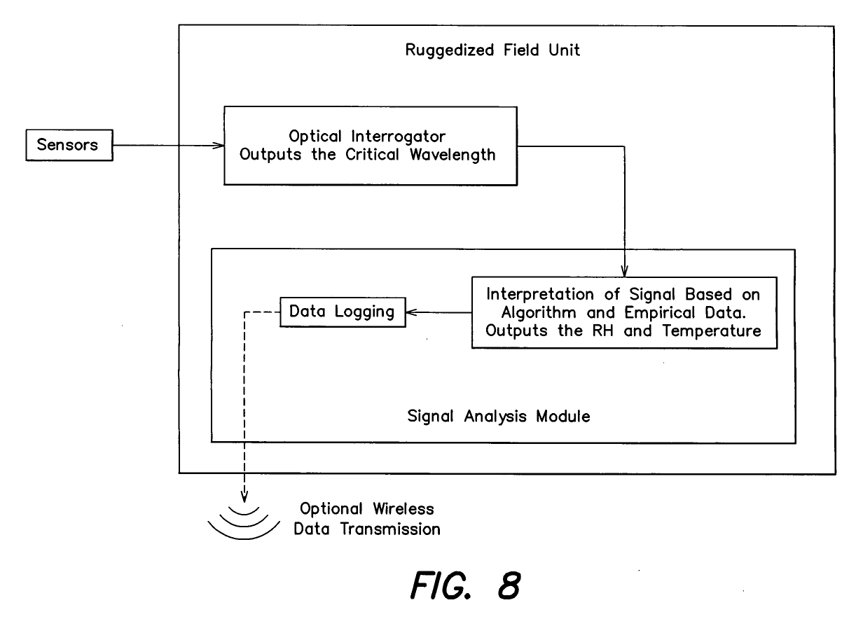

FIG. 8 illustrates another embodiment of a system which may be used with a humidity sensor. As shown, the data from the sensors may be transmitted to a field unit. The data may be sent to an optical interrogator which may output the critical wavelength. Thereafter, the signal from the sensor may be interpreted based on an algorithm and empirical data to output the calculated humidity and/or relative humidity and temperature to a data logger. The humidity and temperature signals may be separated out from each other. This information may then be transmitted wirelessly out of the field unit to a desired location.

In one embodiment, a test setup may be made using salt solutions in accordance with ASTM method E-104-02 to test the sensors in an environment where there is elevated humidity. The particular setup may allow controlled RH from 20 to 100% at temperatures from 32 to 80° F. In one embodiment, a humidity-temperature control setup may be used to establish “baseline” responses for coated FBG probes, meaning the change in center wavelength (CW) as a function of RH at a single temperature. Using a linear regression analysis, the CW vs. RH data were fit to a linear relationship according to the formula:
RH=a₁CW+a₂,

In the above equation, RH is relative humidity, CW is center wavelength of the FBG and a₁ and a₂ are coefficients determined by the regression analysis.

This particular setup may be used over a particular temperature range and humidity range to establish the compensation needed for temperature, as described above. A two-variable linear regression analysis may be used according to the formula:
RH=a₀+a₁(CW−CW₀)+a₂(T−T₀)

In the above equation, T is the temperature, and T₀ and CW₀ are the temperature and center wavelength at a selected value of temperature and RH.

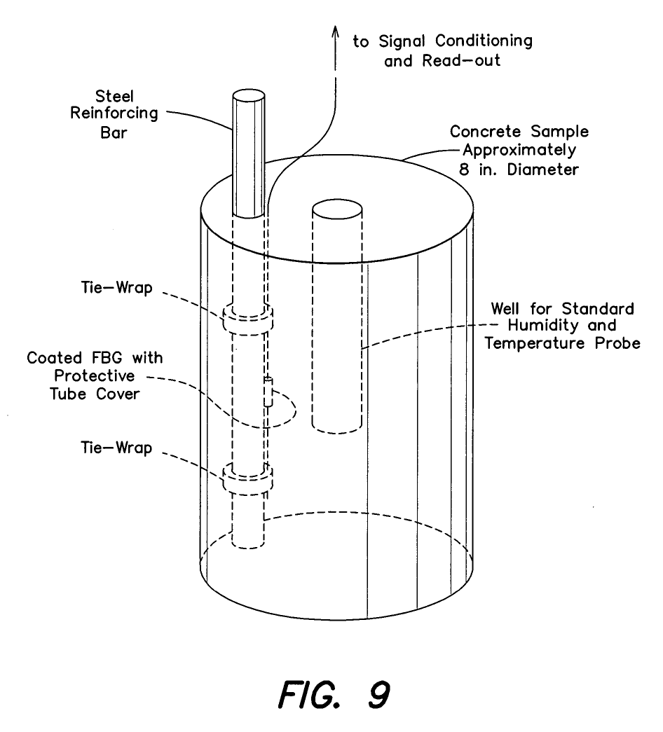

FIG. 9 illustrates one particular test setup for directly embedding a humidity sensor, such as a FBG sensor into concrete. In one test example, commercially available concrete (Quikrete®) was used and cast in 8 in. diameter tubes. The FBG sensor was held in place with a wooden dowel while the concrete was placed in the tube, and a well was inserted in the wet concrete for the humidity probe.

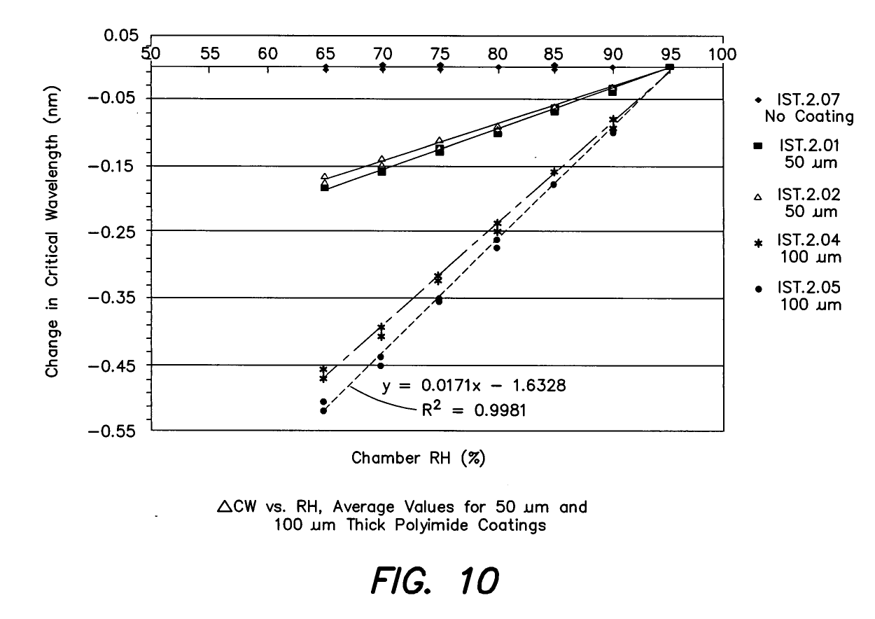

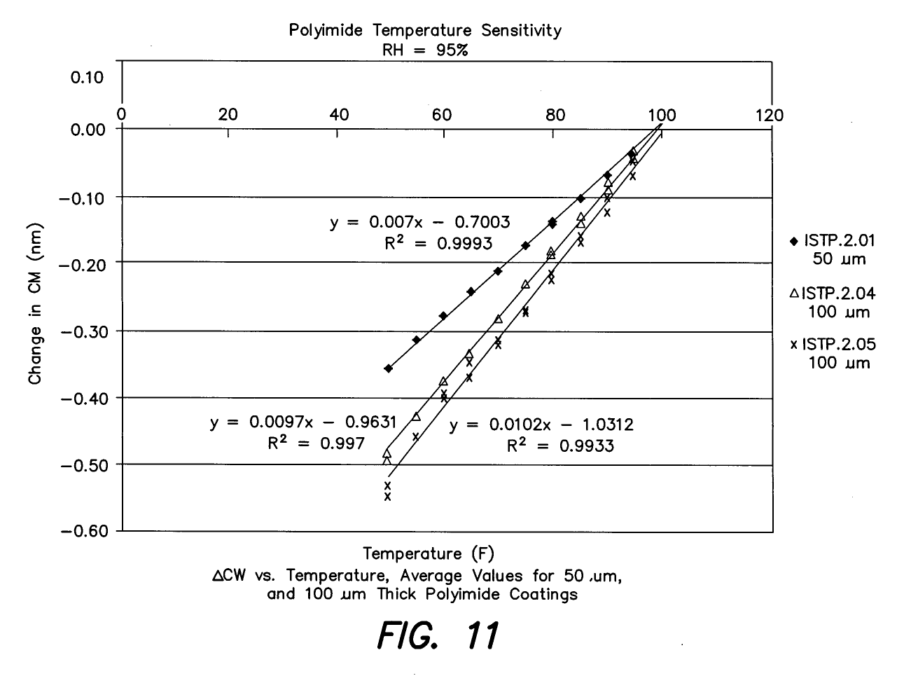

As expected from the coefficient of humidity expansion (CHE) behavior of the polyimide coating and the optical Bragg grating, the change in critical wavelength (CW) with change in RH may be repeatable, as shown in FIGS. 10 and 11. In particular, FIG. 10 illustrates the Chamber Relative Humidity (RH) vs. Change in Critical Wavelength for FBG humidity sensors having a 50 μm and 100 μm thick polyimide coating. FIG. 11 illustrates the Temperature vs. Change in Critical Wavelength at 95% relative humidity for the same FBG sensors. This may be a measure of the temperature sensitivity for a particular sensor. The Coefficient of Determination, R2 shown in FIGS. 10 and 11, is a quantitative measure of the fit of the straight line to the data points.

TABLE 3
Sensitivity of FBG Sensors for Relative Humidity

| | | | Coefficient of |
|---|---|---|---|
| Polyimide coating | | Sensitivity, pm/% RH | Determination |
| 10 micron, | Sample 1 | 2.1 | 0.46 |
| | Sample 3 | 1.3 | 0.76 |
| | Sample 4 | 2.0 | 0.64 |
| 25 micron, | Sample 5 | 3.5 | 0.96 |
| | Sample 6 | 1.3 | 0.71 |
| | Sample 7 | 1.9 | 0.84 |
| 50 micron, | Sample 8 | 3.9 | 0.97 |
| | Sample 9 | 2.1 | 0.96 |
| | Sample 10 | 2.9 | 0.98 |

As shown in Table 3, the sensitivities for the FBG sensors with 50-micron coating range from 2.1 to 3.9 pm/% RH. As expected this is higher than the sensitivities for the 10 and 25-micron thick coatings. The accuracy of the SM120 readout according to Micron Optics is ±2 pm, so the best accuracy with this sensor and readout may be ±0.60% RH. There may be other sources of error that may have an effect on the accuracy, including losses at the connectors, hysteresis of the coating on the FBG, and temperature and strain compensation.

As discussed above, in one embodiment, directional reinforcement of the polyimide coating may be provided to increase CHE-induced strain by placing a sleeve over the FBG region. For example, in one embodiment, a 50-micron FBG sensor with a protective sleeve may be provided. The sleeve may be a PTFE sleeve, commercially available as Teflon®. The sleeve may be a heat-shrinkable tube, and may for example be made by Zeus Industrial Products, Inc. of Orangeburg, S.C. (part number SLW HS). The sleeve may be approximately 50 micron thick, with sufficiently large inner diameter to fit over the coated FBG region (for example, approximately 225 micron, or 0.009 in, diameter).

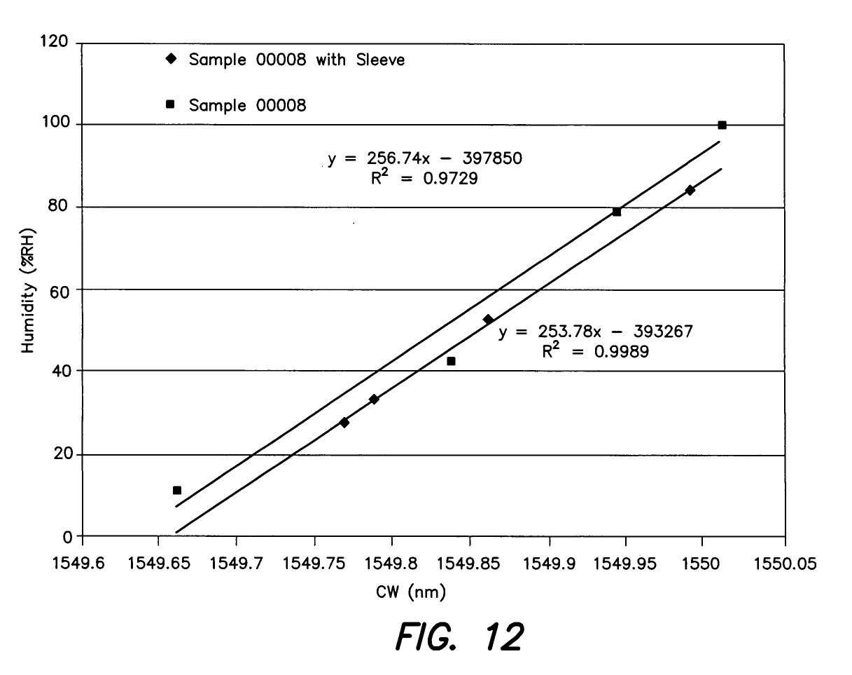

In one embodiment, the sleeve may be cut to a length of approximately 8 cm, and centered over the FBG region (10 mm on the fiber). Polystyrene cement may be used to seal the ends of the sleeve over the acrylic-coated optical fiber. For example, the cement may be placed approximately 4 cm away from the FBG region. As shown in FIG. 12, the FBG sensor with the sleeve may have a substantially identical sensitivity in comparison to a bare FBG (without a sleeve). In one particular embodiment, the sensitivity of both configurations is approximately 3.9 pm-RH⁻¹. In some embodiments, the response time of change in CW with change in RH for the FBG with the sleeve may be longer than the bare FBG, because of the permeation rate of water vapor through the PTFE sleeve. For example, in one embodiment, the time to reach steady state readout was approximately 2 hours with the sleeve and approximately 30 minutes for the bare sensor. It should be appreciated that the use of thinner walled protective tube to provide sufficient chemical resistance may provide a faster response time.

As noted earlier, the polyimide coating expands and contracts with temperature, in accordance with its coefficient of thermal expansion (CTE). Because the output of the FBG sensor may be based on strain induced by the coating, the contribution of thermal strain to the total strain must be subtracted in order to determine the strain due to humidity and/or relative humidity. As discussed above, FIG. 10 illustrates the relation between change in CW with change in RH, and FIG. 11 illustrates the response of the same sensors for the change in CW with temperature at constant 95% RH. The response of one particular sensor with a 50 micron coating may be expressed over the humidity and temperature range using the formula described above:
RH=a₀+a₁(CW−CW₀)+a₂(T−T₀)

In the above equation, in one embodiment, CW₀ is selected at 1550 nm and T₀ is selected at 70° F.

In one embodiment, using a linear 2-variable regression analysis where the coefficients are a₀=90.63, a₁=60.92, a₃=−0.2599, this equation may reduce to:
RH%=90.63+60.92(CW−1550 nm)−0.2599(T−70° F.)

In one embodiment, the thermal expansion of the polyimide produces strain along with hygroscopic strain, and in proportion to the change in temperature, of approximately 10×10⁻⁶ microstrain per ° F. Measuring the temperature and subtracting the calculated thermal strain may result in the value of RH independent of thermal strain.

In one embodiment, a sensor may compensate for temperature variation by using an embeddable temperature probe, such as one based on thermal expansion of a fiber Bragg grating that does not have a hygroscopic coating. Furthermore, in another embodiment, mechanically induced strain may be measured and subtracted, with methods similar to how thermally induced strain may be subtracted from the measurement.

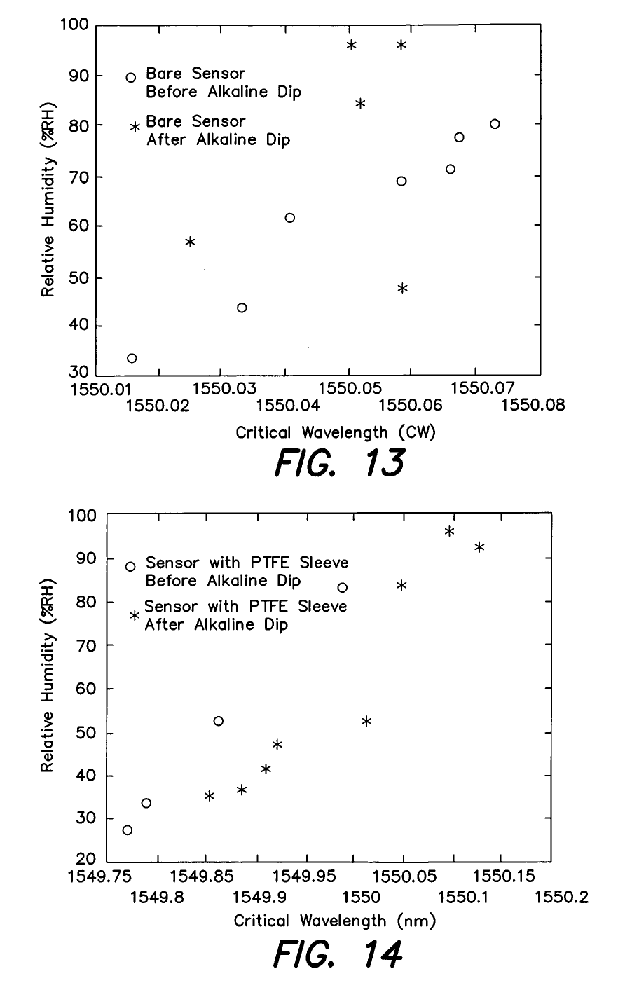

Coated FBG sensors with and without protective sleeves were exposed to simulated pore water solutions found in concrete. Prior literature describes formulations for simulated pore water that result in pH levels of 13 to 13.5. In one test setup, a simulated pore water solutions was made using 0.75 M KOH and 0.75M NaOH in a 10% CaOH solution. Although pH was not measured, the estimated pH of this solution is 13. The performance of FBG sensors without protective sleeves was degraded within 36 hours, due to the weak resistance of the hygroscopic polyimide coating to strong base solutions. However, sensors with the protective sleeve survived well after 36 hours, showing approximately the same response as that prior to immersion in the solution. FIG. 13 illustrates the change in critical wavelength of a particular sensor (No. 016) without any protection sleeve before and after immersion for 48 hours in simulated alkaline pore water. The test indicated that the sensor was not operating properly after immersion, and visual inspection confirmed that the coating was peeling away from the optical fiber.

In contrast, FIG. 14 illustrates results for a similar sensor (No. 008) to the one used in FIG. 13, but with a 50-micron thick PTFE sleeve over the sensor region. This sleeve may protect the hygroscopic polyimide coating. For example, the test illustrated that there was still a good response after immersion in alkaline pore water. As shown in FIG. 14, the slope of the RH vs. Critical Wavelength curve is approximately the same. In some embodiments, there may be a change in offset, which could be due to different temperatures before and after immersion test conditions. The PTFE sleeve may be permeable to gaseous water vapor, but impermeable to liquid water. Because -0H ions dissolve in the liquid water, these corrosive chemicals may not penetrate the sleeve. Thus, certain embodiments of the present invention may include a sleeve which may provide the protection while simultaneously providing sensitivity to humidity.

One embodiment of a humidity sensor was embedded in a concrete test sample used for laboratory experiments. Two concrete test samples were prepared at different water-cement ratios. The first sample was made with slightly less water than the second, resulting in different levels of humidity in the samples. The actual humidity level was measured with a commercial Vaisala humidity and temperature probe, while the output of the FBG sensors was monitored using the same signal conditioning and readout system from earlier lab tests.

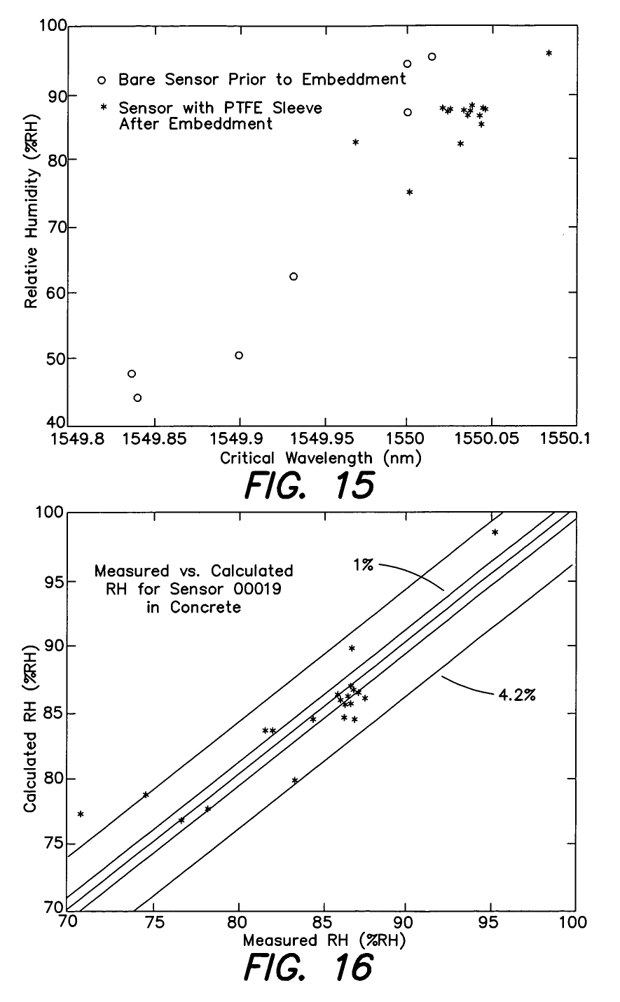

FIG. 15 illustrates the CW and relative humidity for a FBG sensor before and after embedding in concrete. The scatter in the relation between RH and CW may be due to changes in temperature, which may be compensated as described below. The behavior of the FBG sensor in FIG. 15 indicates that the response may not be adversely affected by the PTFE sleeve and/or the embodiment of the sensor in concrete.

The two-variable linear regression analysis discussed above may be used to calculate the humidity and/or relative humidity (RH), based on measurement of the critical wavelength and temperature. According to one embodiment, the temperature and humidity may be measured and recorded with a device, such as a Vaisala probe, and CW data may be collected from the FBG under test over a range of temperature and humidity conditions. The CW and temperature data may be normalized by the following equations: CWₙ=CW−1550 nm, and Tₙ=T−70° F. The regression coefficients a0, a1 and a2 may be calculated for the normalized CW, T and RH data. A second set of data may then be collected for RH and T from the Vaisala probe and also for CW from the FBG under test. The data for CW and T from the second set are applied to the formula to calculate RH with the regression coefficients, and the calculated result from the FBG sensor may be compared with the measured result obtained from the probe.

FIG. 16 illustrates measured and calculated results for a sensor embedded in the concrete, over the range 70% to 100% RH. Only 3 of the 21 data points are outside the error accounted for, above. If the error due to the FBG is approximately ±1% RH, instead of ±0.17% RH, then the cumulative error will be ±4.2% RH from 90% to 100% RH and ±3.2% RH from 0% to 90% RH. This may be reasonable to account for bending strain and non-uniformity in the coating. With this level of error for the FBG, all data points except one are within the error. Therefore, in one embodiment, the error due to the FBG sensor is approximately ±1% over the range of 70% to 100% RH.

The error from may be due to the various factors, including error in measuring the RH and temperature from the Vaisala probe, error in measuring the critical wavelength (CW) from the Micron Optics SM120, bending strain in the FBG sensor caused by placement in the humidity chamber, and the non-uniform coating thickness resulting in irregular strain in the FBG sensor. There may be other minor sources of error, such as aging of the hygroscopic polymer coating, which may alter its output.

The accuracy of the Vaisala HMP 44 probe, according to the manufacturer's specifications is ±2% RH from 0 to 90% RH, ±3% RH from 90 to 100% RH, and ±0.72° F. at 70° F. The thermal strain sensitivity of the coated FBG sensor is in the range of 0.26% RH/° F., based on results summarized above. The specified accuracy of the Micron Optics SM 120 is ±1 pm, and typical coated FBG sensitivities may be approximately 3 to 9 pm/% RH (see previous Table 3), or on average 0.17% RH per pm. The cumulative error of these factors is:
(contribution from RH probe)+(contribution from T probe)+(contribution from FBG)
For 90 to 100% RH: (±3%)+[±0.72(0.26)%]+(±0.17%)_{—}±3.4% RH
For 0 to 90% RH: (±2%)+[±0.72(0.26)%]+(±0.17%)=±2.4% RH

In the above error analysis, only the FBG sensor error due to the SM120 signal conditioning and readout is considered. Other factors such as bending strain in the sensor, and non-uniformity in the coating may also influence the data.

In one embodiment, a plurality of fiber optic sensors to be “strung” on the same fiber, each operating at slightly different center wavelengths. This would permit multiple measurement sites, and/or provide sensing of thermal or other strains as described above needed for isolating the humidity component. For example, in one embodiment, multiple fiber Bragg gratings can be inscribed on an optical fiber forming an array of sensors, spaced along the length of the fiber.

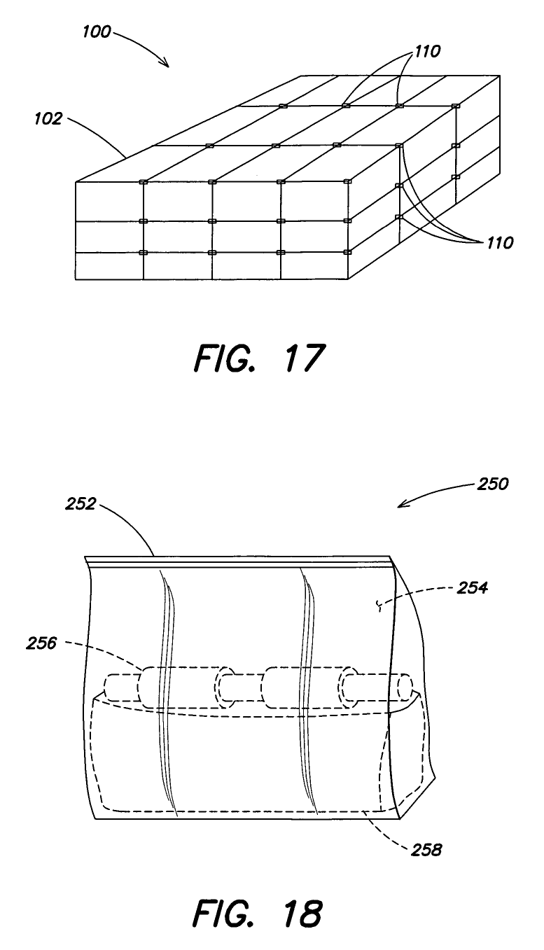

As shown in FIG. 17, a sensor array 100 may include multiple sensing elements 110 distributed along the length of a fiber. In one embodiment, these sensing elements 110 are fiber Bragg grating sensors. The sensing elements 110 may be configured to all be the same type of sensor. For example, in one embodiment, a group of sensing elements 110 may all be configured as humidity sensors. In this embodiment, data may be obtained at a variety of locations throughout a sample, such as a piece of concrete 102. In another embodiment, a group of sensing elements 110 may be configured as different types of sensors, such as for example, humidity sensors, temperature sensors, strain sensors, or other suitable sensors as the present invention is not so limited.

The sensor array 100 with a plurality of sensing elements 110 may be configured in a one dimensional array. In another embodiment, the sensor array 100 may be configured in a two dimensional array, and in yet another embodiment, the sensor array 100 may be configured in a three dimensional array. The sensor array may include both embedded and non-embedded sensors. Also, with the flexibility of the optical fiber, the sensor array may be conformed into non-uniform shapes, such as curved or bent structures.

When a plurality of fiber Bragg gratings are inscribed on an optical fiber to form multiple sensor, each grating may have a respective address. In other words, when light is transmitted through the optical fiber a certain peak wavelength will be associated with a particular grating. One grating may not be able to produce the same peak wavelength as another grating on that optical fiber. Therefore, by analyzing the resulting peak wavelength, one may be able to determine which particular grating produced that particular peak.

In one illustrative embodiment shown in FIG. 18, a fiber optic based humidity sensor is packaged within a relatively high humidity chamber. In this embodiment, the sensor may be able to detect a high humidity as soon or shortly after it is placed in a high working environment because the sensor is already at or is close to the humidity level of the working environment. As shown in the embodiment shown in FIG. 18, a kit 200 of parts includes an openable, non-porous package 202 having a chamber 204 which is held at a relatively high humidity. With the fiber optic based humidity sensor 206 enclosed within the package 202, the sensor is maintained in a high moisture, high humidity environment.

In one embodiment, the non-porous package 202 may be formed of a material such as plastic, glass, or other suitable non-porous materials, as the present invention is not limited in this respect.

The kit may include a moisture element 208 disposed within the package 202 to provide moisture in the chamber 204. In one embodiment, the moisture element is a porous structure capable of retaining fluid, and may for example be a sponge. However, it should be appreciated that a moisture element may not be required in all embodiments as the present invention is not limited in this regard.

One aspect of the invention is directed to a method of calibrating a fiber optic based humidity sensor. It has been found that the sensor takes longer to reach a high humidity level from a low humidity level than reaching a low humidity level from a high humidity level. The calibration method may include placing the sensor in a humidity chamber that is at a relatively high humidity, without first placing the sensor in the humidity chamber at a relatively low humidity. Thereafter, the humidity within the chamber may be reduced. A signal from the sensor may be obtained and the signal may be correlated with the humidity in the chamber. As discussed above, this method may speed up the calibration process. The reducing, obtaining and correlating steps may be repeated until a desired range of signals are obtained.

In one embodiment, the sensor is calibrated by placing the sensor in a humidity chamber that is at approximately 95% relative humidity. In another embodiment, the sensor is placed in a humidity chamber that is at approximately 100% relative humidity. When reducing the humidity within the chamber, the humidity may be reduced by approximately 5% increments. In another embodiment, the humidity may be reduced by approximately 1% increments.

It should be appreciated that various embodiments of the present invention may be formed with one or more of the above-described features. The above aspects and features of the invention may be employed in any suitable combination as the present invention is not limited in this respect. It should also be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one drawing figure, and/or may also encompass embodiments combining components illustrated in multiple different drawing figures.

It should be understood that the foregoing description of various embodiments of the invention are intended merely to be illustrative thereof and that other embodiments, modifications, and equivalents of the invention are within the scope of the invention recited in the claims appended hereto.

What is claimed is:

1. A kit of parts, comprising:
an openable, non-porous package defining a chamber, wherein the chamber is held at a relatively high humidity; and,
a fiber optic based humidity sensor enclosed within the package.

2. The kit of claim 1, wherein the fiber optic based sensor comprises a fiber Bragg grating sensor.

3. The kit of claim 2, wherein the fiber Bragg grating sensor comprises an optical fiber with a hygroscopic coating thereon.

4. The kit of claim 3, wherein the hygroscopic coating comprises polyimide.

5. The kit of claim 3, wherein the fiber Bragg grating sensor comprises a selectively permeable covering adapted to substantially allow water vapor to flow through the covering and substantially prevent liquid water to flow through the covering.

6. The kit of claim 5, wherein the covering comprises PTFE.

7. The kit of claim 3, wherein the fiber Bragg grating sensor comprises a relatively rugged container, the container positioned over the optical fiber with the hygroscopic coating thereon and the covering.

8. The kit of claim 7, wherein the container is porous.

9. The kit of claim 7, wherein the container is a metal sleeve.

10. The kit of claim 1, further comprising a temperature sensor enclosed within the package.

11. The kit of claim 10, wherein the temperature sensor is a fiber Bragg grating sensor comprising an optical fiber with a hygroscopic coating thereon.

12. The kit of claim 11, wherein the hygroscopic coating comprises acrylate.

13. The kit of claim 1, further comprising a temperature sensor enclosed within the package, wherein the humidity sensor and the temperature sensor each comprise an optical fiber with a hygroscopic coating thereon, wherein the humidity sensor and the temperature sensor are disposed on a single optical fiber.

14. The kit of claim 1, further comprising a moisture element disposed within the package, the moisture element configured to provide moisture in the chamber.

15. The kit of claim 14, wherein the moisture element comprises a sponge.

16. A method of calibrating a fiber optic based humidity sensor, the method comprising:
a) placing the sensor in a humidity chamber that is at a relatively high humidity, without first placing the sensor in the humidity chamber at a relatively low humidity;
b) thereafter reducing the humidity within the chamber;
c) obtaining a signal from the sensor; and
d) correlating the obtained signal with the humidity in the chamber.

17. The method of claim 16, further comprising repeatedly performing b), c) and d), in order, until a desired range of signals are obtained.

18. The method of claim 17, wherein placing the sensor in a humidity chamber that is at a relatively high humidity comprises placing the sensor in a humidity chamber that is at approximately 95% relative humidity.

19. The method of claim 18, wherein reducing the humidity within the chamber comprises reducing the humidity within the chamber by approximately 5% increments.

20. The method of claim 18, wherein reducing the humidity within the chamber comprises reducing the humidity within the chamber by approximately 1% increments.

21. The method of claim 16, wherein placing the sensor in a humidity chamber that is at a relatively high humidity comprises placing the sensor in a humidity chamber that is at approximately 100% relative humidity.

22. The method of claim 21, wherein reducing the humidity within the chamber comprises reducing the humidity within the chamber by approximately 5% increments.

23. The method of claim 21, wherein reducing the humidity within the chamber comprises reducing the humidity within the chamber by approximately 1% increments.
